(19) United States
(12) Patent Application Publication
(10) Pub. No.: US 2013/0089221 A1
(43) Pub. Date: Apr. 11, 2013

(54) SOUND REPRODUCING APPARATUS

(71) Applicant: KOREA ADVANCED INSTITUTE OF SCIENCE A, Yuseong-gu (KR)

(72) Inventors: Yang-Hann Kim, Yuseong-gu (KR); Min-Ho Song, Yuseong-gu (KR); Jung-Woo Choi, Seo gu (KR)

(73) Assignee: KOREA ADVANCED INSTITUTE OF SCIENCE AND TECHNOLOGY, Yuseong-gu (KR)

(21) Appl. No.: 13/647,709

(22) Filed: Oct. 9, 2012

(30) Foreign Application Priority Data
Oct. 10, 2011 (KR) 10-2011-0102849

(51) Int. Cl. H04R 1/40

(52) U.S. Cl. 381/97

(57) ABSTRACT

A sound reproducing apparatus is provided to include a control device configured to receive first and second sound source signals, controls magnitudes and phases of the received first and second sound source signals to be heard as if sound is reproduced at a pre-determined position within a listening space, and to output first and second controlled sound source signals; a first speaker configured to receive the first controlled sound source signal and to reproduce sound; a second speaker configured to receive the second controlled sound source signal and to reproduce sound; and an input device with which a user can draw the listening space and mark the pre-determined position and the user's position in the drawn listening space, wherein the pre-determined position is distant from the user, wherein the input device is made of a touch panel and the user can draw the listening space with his/her finger or a pen and mark the pre-determined position and the user's position through the touch panel, and wherein the control device controls the magnitudes and phases of the first and second sound source signals to be heard as if sound is reproduced at an actual pre-determined position within the listening space corresponding to the pre-determined position marked on the input device, and outputs the first and second controlled sound source signals.

### CROSS-REFERENCE TO RELATED APPLICATIONS

This application claims priority under 35 U.S.C. §119 to Korea Patent Application No. 10-2011-0102849 filed on Oct. 10, 2011, the entirety of which is hereby incorporated by reference.

### FIELD OF THE INVENTION

The present invention relates to a sound reproducing apparatus.

### BACKGROUND OF THE INVENTION

Sound field control technology using a plurality of sound sources has been generally developed in order to improve the acoustic characteristics at some designated positions in space. However, recently, technology has been developing to improve the acoustic characteristics of a specific zone (i.e. where a listener exists). Sound field control technology using a plurality of sound sources can be categorized into two groups in general. One is an active noise control that reduces sound level of a zone by changing the magnitude/phase input to a plurality of sound sources actively. The other is a control that increases the emitted sound power for a specific angle by changing a gap between sources that are arranged in a specific shape [R. C. Jones, “On the theory of the directional patterns of continuous source distributions on a plane surface,” J. Acoust. Soc. Am. 16(3), 147-171(1945)] or by changing the time delay and magnitude input between each sound source [R. L. Prichard, “Maximum directivity index of a linear point array,” J. Acoust. Soc. Am. 26, 1034-1039(1954)]. The latter was studied for the active sonar. As representative, Dolph has proposed a mathematical solution having a weight function of a sound source array that generates a sidelobe of constant magnitude so that the emitted acoustic power at a specific directional angle is not affected by the sidelobe [C. L. Dolph, “A current distribution for broadside arrays which optimizes the relationship between beamwidth and sidelobe level,” Proc. IRE 34(6), 335-348 (1946)].

But, it was difficult to apply in the case of an arbitrary source array because it was the mathematical solution for a specific source array. So, the optimization technique for getting maximum emitted sound power to a specific direction in the case of an arbitrary sound source array has been studied by Streit [Roy L. Streit, “Optimization of discrete array of arbitrary geometry,” J. Acost. Soc. Am. 69(1), 199-212 (1981)]. However, this research assumed only an arbitrary sound source array and is not suitable for applying to a common listening space that reflects several acoustic phenomena due to various radiation patterns of sources, reflection/absorption of walls and etc.

The technology controlling sound pressure level in the space where the listener exists has been studied as active noise control [P. Lueg 1936 Process of silencing sound oscillations. U.S. Pat. No. 2,043,416], which is not same with the research optimizing the emission pattern.

The active noise control is a noise reduction method by actively controlling acoustic potential energy or sound power generated by background noise source using second sound sources. It is effective to obtain the silence against the listener or the total space in low frequency range. In this case, the space where the silence is successively gotten by controlling noise is called a quiet zone.

Further, the technology controlling indirect characteristics like directionality by using restrictive assumption that is neglecting the distance to the listener or reflection and the like is known to all by U.S. Pat. No. 5,802,190 (Linear speaker array). The method of reproducing a signal without distortion by using transfer function is also known to all by U.S. Pat. No. 5,910,990 (Apparatus and method for automatic equalization of personal multi-channel audio system).

Consequently, the conventional sound field control methods using a plurality of sound sources are mainly originated by changing the time delay between sound sources and the input magnitude simply, or changing the directionality of emitted sound power by using a restrictive array type of sound source without considering the variable location of the listener or the space where the listener exists. Also, there is the problem that it is not possible to reflect the acoustic characteristics of the listening space due to radiation, reflection, absorption, and so on, because the conventional methods only assume free field condition.

### SUMMARY OF THE INVENTION

An object of the present invention is to provide a sound reproducing apparatus which provide sound environments optimized to a user by reproducing sound having a desired spatial characteristic within a listening space.

A sound reproducing apparatus according first aspect of the present invention includes a control device configured to receive first and second sound source signals, to control magnitudes and phases of the received first and second sound source signals to be heard as if sound is reproduced at a pre-determined position within a listening space, and to output first and second controlled sound source signals; a first speaker configured to receive the first controlled sound source signal and to reproduce sound; a second speaker configured to receive the second control sound source signal and to reproduce sound; and an input device with which a user can draw the listening space and mark the pre-determined position and the user's position in the drawn listening space, wherein the pre-determined position is distant from the user, wherein the input device is made of a touch panel and the user can draw the listening space with his/her finger or a pen and mark the pre-determined position and the user's position through the touch panel, and wherein the control device controls the magnitudes and phases of the first and second sound source signals to be heard as if sound is reproduced at an actual pre-determined position within the listening space corresponding to the pre-determined position marked on the input device, and outputs the first and second controlled sound source signals.

Accordingly, the control device receives the first and second sound source signals, controls magnitudes and phases of the received first and second sound source signals to be heard as if sound is reproduced at a pre-determined position within a listening space, and outputs first and second control sound source signals. The first speaker receives the first controlled sound source signal and reproduces sound. The second speaker receives the second controlled sound source signal and reproduces sound. Here, only the first speaker and the second speaker are described, but this shows only the order of the speakers, this is not limited to only two speakers. Practically, it is realized by the array of speakers. Further, the pre-determined position is distant from the user, and the sound is heard as if the sound is reproduced at this pre-determined position. In order to make the sound be heard as if the sound is reproduced at this pre-determined position within the listening space, the controlled sound source signal of which the magnitudes and phases are controlled is input to the speakers.

Accordingly, the sound reproducing apparatus according to first aspect of the present invention makes the sound be heard as if the sound is reproduced at this pre-determined position within the listening space, so that a user can listen to the sound as if it is reproduced at his/her desired position. Thus, it is possible to provide sound environments optimized to a user's demand.

In addition, since the sound is heard as if the sound is reproduced at the pre-determined position by marking the pre-determined position and the user's position within the listening space formed through the input device made of the touch panel, a user can listen the sound as if the sound is reproduced by the control of the sound source signal through convenient input at anytime and anywhere. Thus, it is possible to provide sound environments optimized to a user's demand.

The sound reproducing apparatus according to second aspect of the present invention includes a control device configured to receive first and second sound source signals, to control magnitudes and phases of the received first and second sound source signals so that a sound pressure level in a pre-determined position within a listening space is higher than sound pressure levels in positions except the pre-determined position, and to output first and second controlled sound source signals; a first speaker configured to receive the first controlled sound source signal and to reproduce sound; a second speaker configured to receive the second control sound source signal and to reproduce sound; and an input device with which a user can draw the listening space and mark the pre-determined position and a user position in the drawn listening space, wherein the pre-determined position is distant from a user, wherein the input device is made of a touch panel and the user can draw the listening space with his/her finger or a pen and mark the pre-determined position and the user position through the touch panel, and wherein the control device controls the magnitudes and phases of the first and second sound source signals to be heard as if sound is reproduced at an actual pre-determined position within the listening space corresponding to the pre-determined position marked on the input device, and outputs the first and second controlled sound source signals.

Accordingly, the control device receives the first and second sound source signals, controls magnitudes and phases of the first and second sound source signals so that a sound pressure level in a pre-determined position within a listening space can be higher than sound pressure levels in positions except the pre-determined position, and outputs first and second control sound source signals. The first speaker receives the first control sound source signal and reproduces sound. The second speaker receives the second control sound source signal and reproduces sound. Here, the first and second speakers are disclosed to describe order of speakers, and thus the number of speakers does not limited to two. In practice, the first and second speakers are achieved by a speaker array. Further, the pre-determined position is distant from the user, and the sound pressure level in this pre-determined position is made to be higher than sound pressure levels in positions except the pre-determined position. In order to make a sound pressure level in a pre-determined position within a listening space be higher than sound pressure levels in positions except the pre-determined position, the control sound source signal of which the magnitudes and phase are controlled is inputted to the speaker.

Accordingly, the sound reproducing apparatus according to second aspect of the present invention makes the sound pressure level in a pre-determined position within a listening space is higher than sound pressure levels in positions except the pre-determined position, and thus a user can listen the sound as if the sound is reproduced at his/her desired position. Accordingly, it is possible to provide sound environments optimized to a user's demand.

Since the pre-determined position and the user's position within the listening space drawn through the touch panel of the input device are marked so that a sound pressure level in a pre-determined position within a listening space is higher than sound pressure levels in positions except the pre-determined position, a user can listen the sound as if the sound is reproduced at the pre-determined through convenient input at anytime and anywhere. Accordingly, it is possible to provide sound environments optimized to a user's demand.

A sound reproducing apparatus according to third aspect of the present invention includes a control device configured to receive first and second sound source signals, to control magnitudes and phases of the received first and second sound source signals to maximize a ratio of the acoustic potential energy density at a pre-determined position within a listening space to a sum of the energy of the first sound source signal and the energy of the second sound source signal, and to output first and second controlled sound source signals; a first speaker configured to receive the first controlled sound source signal and to reproduce sound; a second speaker configured to receive the second controlled sound source signal and to reproduce sound; and an input device with which a user can draw the listening space and mark the pre-determined position and a user position on the drawn listening space, wherein the pre-determined position is distant from a user, wherein the input device is made of a touch panel and the user can draw the listening space with his/her finger or a pen and mark the pre-determined position and the user position through the touch panel, and wherein the control device controls the magnitudes and phases of the first and second sound source signals to be heard as if sound is reproduced at an actual pre-determined position within the listening space corresponding to the pre-determined position marked on the input device, and outputs the first and second controlled sound source signals.

Accordingly, the control device receives the first and second sound source signals, controls magnitudes and phases of the first and second sound source signals to maximize a ratio of the acoustic potential energy density at a pre-determined position within a listening space to a sum of the energy of the first sound source signal and the energy of the second sound source signal, and outputs first and second control sound source signals. The first speaker receives the first controlled sound source signal and reproduces sound. The second speaker receives the second controlled sound source signal and reproduces sound. Here, only the first speaker and the second speaker are described, but this shows only the order of the speakers, this is not limited to only two speakers. Practically, it is realized by the array of speakers. Further, the pre-determined position is distant from the user, and a ratio of the acoustic potential energy density at a pre-determined position within a listening space to a sum of the energy of the first sound source signal and the energy of the second sound source signal is maximized. In order to maximize the ratio of the acoustic potential energy density at a pre-determined position within a listening space to total energy of the first and second sound source signals, the control sound source signal of which the magnitudes and phase are controlled is inputted to the speakers.

Accordingly, the sound reproducing apparatus according to third aspect of the present invention maximizes a ratio of the acoustic potential energy density at a pre-determined position within a listening space to a sum of a energy of the first sound source signal and a energy of the second sound source signal, and thus a user can listen the sound as if it is reproduced at his/her desired position. Accordingly, it is possible to provide sound environments optimized to a user's demand.

Since the pre-determined position and the user's position within the listening space drawn through the touch panel of the input device are marked to maximize a ratio of the acoustic potential energy density at a pre-determined position within a listening space to a sum of a energy of the first sound source signal and a energy of the second sound source signal, a user can listen the sound as if the sound is reproduced at pre-determined position through convenient input at anytime and anywhere. Accordingly, it is possible to provide acoustic environments optimized to a user's demand.

Under the sound reproducing apparatus according to any one of first to third aspects of the present invention, the sound reproducing apparatus according to fourth aspect of the present invention describes that the user can mark one or not less than two pre-determined positions on the touch panel of the input device, and the control device controls the magnitudes and phases of the first and second sound source signals to be heard as if sound is reproduced at an actual pre-determined position within the listening space corresponding to the one or not less than two pre-determined positions marked on the touch panel of the input device, and outputs the first and second control sound source signals

In the sound reproducing apparatus according to fourth aspect of the present invention, since one or not less than two pre-determined positions where the sound is heard as if it is reproduced are marked on the touch panel of the input device, so that a user can feel as if the sound is generated at the one or not less than two points where the acoustic focusing points are placed, through convenient input at anytime and anywhere.

Under the sound reproducing apparatus according to any one of first to third aspects of the present invention, the sound reproducing apparatus according to fifth aspect of the present invention discloses that the user can move the marked pre-determined position on the input unit, and the control device controls the magnitudes and phases of the first and second sound source signals to be heard as if sound is reproduced at an actual pre-determined position within the listening space corresponding to the pre-determined position moved on the input unit, and outputs the first and second control sound source signals.

In the sound reproducing apparatus according to fifth aspect of the present invention, since the pre-determined positions where the sound is heard as if it is reproduced can be moved on the touch panel of the input unit, so that a user can change the position where the sound is reproduced, by control of the sound source signal through convenient input at anytime and anywhere.

Under the sound reproducing apparatus according to any one of first to third aspects of the present invention, the sound reproducing apparatus according to sixth aspect of the present invention describes that the input device displays magnitudes of sound at the pre-determined position, the user can change the magnitudes of the sound by touching the pre-determined position marked on the touch panel of the input unit, and the control device controls the magnitudes and phases of the first and second sound source signals to be heard as if sound is reproduced with the changed magnitudes at an actual pre-determined position within the listening space corresponding to the pre-determined position marked on the touch panel of the input unit, and outputs the first and second control sound source signals

In the sound reproducing apparatus according to sixth aspect of the present invention, the pre-determined positions where the sound is heard as if it is reproduced are touched on the touch panel of the input unit to change the magnitudes of the sound, so that a user can control the magnitudes of the sound, by control of the sound source signal through convenient input at anytime and anywhere.

### BRIEF DESCRIPTION OF THE DRAWINGS

Arrangements and embodiments may be described in detail with reference to the following drawings in which like reference numerals refer to like elements and wherein:

FIG. 1 is a schematic drawing for explaining theory relating to the present invention.

FIG. 2 shows a configuration of the sound reproducing apparatus based on its actual operations.

FIG. 3 is a flowchart showing processes of generating a pre-determined position, where sound is reproduced in the listening space by using the sound reproducing apparatus.

FIGS. 4a to 4e are schematic drawings showing that a listening space, a listener position and an acoustic focusing point are illustrated on a touch panel according to the exemplary embodiments.

### DETAILED DESCRIPTION OF THE EMBODIMENTS

Below, embodiments may be described in detail with reference to the accompanying drawings. However, the embodiments may be modified in various forms, and the ranges are not limited to the following the embodiments. Throughout the drawings, the shape, size, etc. of the elements may be exaggerated for clear description, and like numerals refer to like elements.

First, theoretic backgrounds related to an exemplary embodiment will be described in detail.

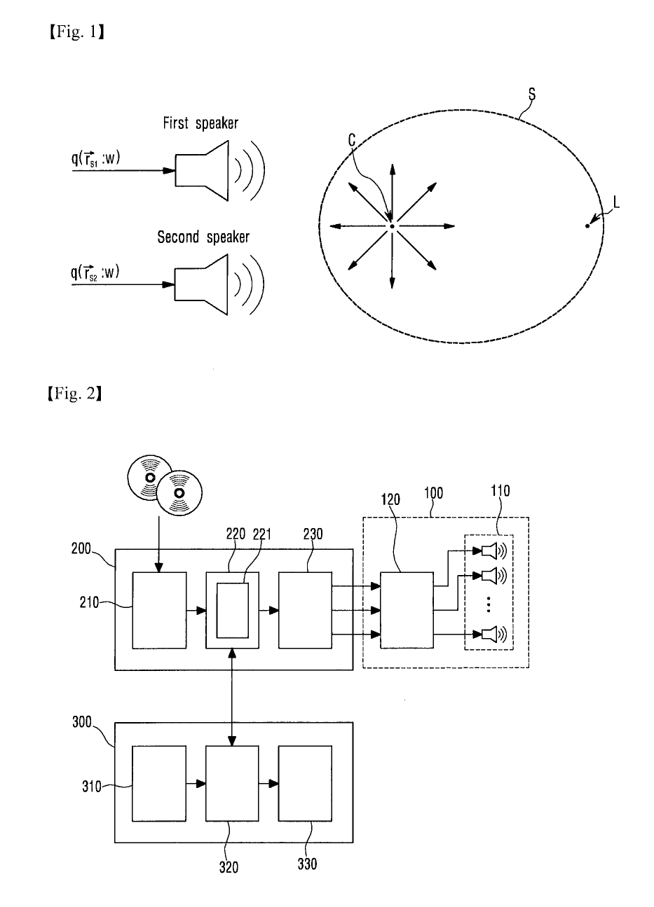

FIG. 1 is a schematic view for explaining theory related to the present exemplary embodiment. FIG. 1 schematically illustrates a listening space S in which a first speaker and a second speaker used as sound sources are installed. Also, the listening space S is a space where a listener (user) is positioned, and a listener Position L is a position where the listener is currently positioned within the listening space. FIG. 1 shows one acoustic bright point, but not limited thereto. Alternatively, if there are many acoustic bright points, many acoustic bright points may be shown within the listening space S in FIG. 1.

1. Determination of Input Signal with Regard to One Acoustic Bright Point

If there are first to nth sound sources within the listening space S, sound pressure p(\vec{r};ω), generated by the first to nth sound sources, at an arbitrary point c (an acoustic bright point or an acoustic focusing point) within the listening space S can be represented by the following Equation 1.

$$p ( \vec{r} , ω ) = {\sum }_{i = 1}^{N} G ( \vec{r} \vert {\vec{r}}_{s , i} ; ω ) {q}_{i} ( ω ) \qquad [ Equation 1 ]$$

where, \vec{r} indicates a spatial point, and r_{s,i} indicates a position of ith sound source. Further, G(\vec{r}|\vec{r}_{s,i};ω) is a transfer function of expressing a correlation between \vec{r} and \vec{r}_{s,i}. The transfer function may be easily obtained by a definition of a mathematical model or a practical measurement. With regard to the point \vec{r} on the space, the transfer function between the first to nth sound sources can be represented in the form of matrix like the following Equation 2.

G(\vec{r})=└G(\vec{r}|\vec{r}_{s,1};ω) G(\vec{r}|\vec{r}_{s,2};ω) . . . G(\vec{r}|\vec{r}_{s,N};ω)┘ [Equation 2]

The spatial correlation matrix R_{b} with regard to the spatial point \vec{r} is defined as follows.

R_{b}(\vec{r})=G(\vec{r})^{H}G(\vec{r}) [Equation 3]

Acoustic potential energy density e_{b} at one point \vec{r} can be represented by an inner product of the spatial correlation matrix and an input solution, which is represented be the Equation 4.

e_{b}=q^{H}R_{b}q [Equation 4]

It is possible to obtain an input solution vector q that maximizes the acoustic potential energy at one point \vec{r} with regard to pre-determined input power, which is called acoustic brightness control. If the acoustic brightness control is performed with regard to one point \vec{r}, the input solution vector q for controlling N sound sources is represented by the Equation 5.

$$q = \frac{{G ( \vec{r} )}^{H}}{‖ {G ( \vec{r} )}^{H} ‖} = \frac{{[ \begin{matrix}\overline{G} ( \vec{r} \vert {\vec{r}}_{s , 1} ; ω ) & \overline{G} ( \vec{r} \vert {\vec{r}}_{s , 2} ; ω ) & … & \overline{G} ( \vec{r} \vert {\vec{r}}_{s , N} ; ω )\end{matrix} ]}^{T} \vert}{‖ {G ( \vec{r} )}^{H} ‖} \qquad [ Equation 5 ]$$

where, ∥G(\vec{r})^{H}∥ is the length of vector G(\vec{r}) defined in the Equation 2, and calculated by Equation 6.

$$\frac{q}{‖ q ‖}$$

Through the vector q of the Equation 5, it is possible to calculate a magnitude and phase difference of an audio signal output from each sound source. The magnitude |qᵢ| of the audio signal inputted to the ith speaker is calculated by the Equation 7.

$$‖ {G ( \vec{r} )}^{H} ‖ \sqrt{{\vert G ( \vec{r} \vert {\vec{r}}_{s , 1} ; ω ) \vert}^{2} + {\vert G ( \vec{r} \vert {\vec{r}}_{s , 2} ; ω ) \vert}^{2} + … {\vert G ( \vec{r} \vert {\vec{r}}_{s , N} ; ω ) \vert}^{2}} \qquad [ Equation 6 ]$$

The phase difference qᵢ of the audio signal inputted to the ith speaker can be obtained by argument of a complex number.

2. Determination of Input Signal with Regard to Many Acoustic Bright Points

If there are not less than two points used by a user to control an acoustic field, the control may be performed as follows. Let M points on the space be [symbol] , the solution of the acoustic brightness control for each point can be represented by the Equation 8.

$$\vert {q}_{i} \vert = \frac{\vert G ( \vec{r} \vert {\vec{r}}_{s , 2} ; ω ) \vert}{‖ {G ( \vec{r} )}^{H} ‖} \qquad [ Equation 7 ]$$

The input solution about many points can be defined by the Equation 9.

q=α₁q₁+α₂q₂+ . . . +α_{M}q_{M} [Equation 9]

If the number of points to be controlled becomes larger, the magnitude of the input solution may increase continuously. Therefore,

$${q}_{1} = \frac{{G ( {\vec{r}}_{1} )}^{J}}{‖ {G ( {\vec{r}}_{1} )}^{H} ‖} , {q}_{2} = \frac{{G ( {\vec{r}}_{2} )}^{H}}{‖ {G ( {\vec{r}}_{2} )}^{H} ‖} , … , {q}_{M} = \frac{{G ( {\vec{r}}_{M} )}^{H}}{‖ {G ( {\vec{r}}_{M} )}^{H} ‖} \qquad [ Equation 8 ]$$

obtained by normalizing the input solution is used as the control input solution of N sound sources.

where, ∥q∥ is defined by the Equation 4, and αᵢ is a constant for adjusting the intensity of ith point and has a real number between 0 and 1. If αᵢ is set to 0, the intensity of the ith point is regarded as 0 and not used. If αᵢ is set to 1, the brightness focused by the acoustic brightness control is used by 100%.

Below, embodiments may be described in detail with reference to the accompanying drawings.

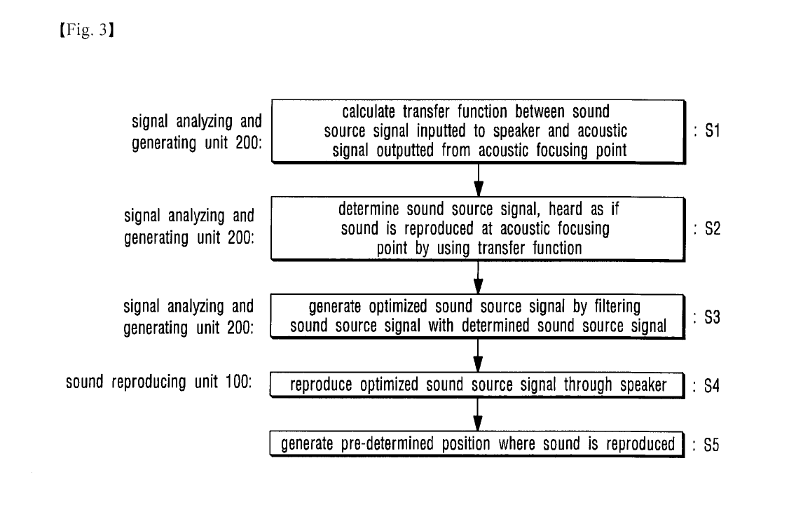

FIG. 2 shows a configuration of the sound reproducing apparatus based on its actual operations;

As shown in FIG. 2, the sound reproducing apparatus of the embodiments includes a sound reproducing unit 100, a signal analyzing and generating unit 200, and a user controller 300.

The sound reproducing unit 100 includes a plurality of speakers 110 corresponding to the plurality of sound sources, and a multi-channel audio amplifier 120 capable of driving the plurality of speakers 110.

The signal analyzing and generating unit 200 includes a playback device 210 which can receive digital data from CD, MP3, etc. having an input audio signal, a signal analyzer 220 which receives an original sound signal from the playback device 210 and a control signal q from the user controller 300 and performs a signal analysis, and a multi-channel signal generator 230 which receives information from the signal analyzer 220 and gives individual sound source signals synchronized by the multi-channel audio amplifier 120 to the respective speakers 110. The signal analyzer 220 includes a multi-channel signal analyzer 221 that determines a sound source signal heard as if the sound is reproduced at a pre-determined position, i.e., at an acoustic focusing point within the listening space, and transmits the determination information to the multi-channel signal generator 230. Specifically, in terms of determining the sound source signal, the sound source signal is determined such that the sound pressure level at the acoustic focusing point is higher than at points except the acoustic focusing point. More specifically, the sound source signal is determined to such that a ratio of the acoustic potential energy density at the acoustic focusing point to a sum of energies of individual sound source signals is maximized.

The user controller 300 includes an input device 310 to receive a user's input about the number, position, intensity, etc. of acoustic bright points, a transceiver 320 to transmit and receive data to and from the signal analyzing and generating unit 200, and a display unit 330 to display a current control state.

Thus, the sound reproducing apparatus reproduces sound as if sound is reproduced at a pre-determined position within the listening space, thereby allowing a listener to hear as if sound is reproduced at a desired position and providing acoustic environments optimized to a listener's demand.

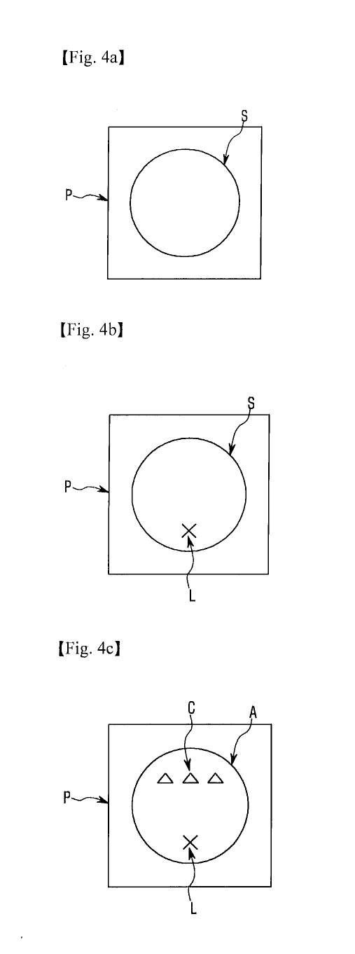

FIG. 3 is a flowchart showing processes of generating a pre-determined position, where sound is reproduced in the listening space by using the sound reproducing apparatus.

First, at step S1, the signal analyzer 220 of the signal analyzing and generating unit 200 calculates the transfer function between a sound signal output from the acoustic focusing point and a sound source signal input to the speaker 110, in accordance with positions of the acoustic focusing point selected by a user with the input device 310 of the user controller 300.

At step S2, the signal analyzer 220 of the signal analyzing and generating unit 200 determines the sound source signal heard as if sound is reproduced at the acoustic focusing point by using the transfer function calculated at the step S1, and transmits the determination information to the multi-channel signal generator 230. Specifically, in terms of determining the sound source signal, the sound source signal is determined such that the sound pressure level at the acoustic focusing point is higher than in points except the acoustic focusing point. More specifically, the sound source signal is determined such that a ratio of the acoustic potential energy density at the acoustic focusing point to a sum of energies of individual sound source signals is maximized. Here, the determination of the sound source signal is described with regard to a single frequency. However, in the case of a plurality of frequencies, it will be appreciated that the sound source signal is determined with regard to each frequency. Also, the sound source signal determined herein serves as a filtering coefficient used when filtering the sound source signal (arbitrary sound desired to be heard as if it is reproduced at a pre-determined position within the listening space) in the following step S3.

At step S3, the multi-channel signal generator 230 of the signal analyzing and generating unit 200 filters the sound source signal with the sound source signal determined at the step S2 based on the information received from the signal analyzer 220, generates a sound source signal (the filtered sound source signal), i.e., a controlled sound source signal optimized to generate a pre-determined position where the sound is reproduced in the listening space, and transmits the controlled sound source signal to the sound reproducing unit 100. Here, the determination of the sound source signal is described with regard to a single frequency. However, in the case of a plurality of frequencies, it will be appreciated that the sound source signal is filtered with the determined sound source signal, and the optimized sound source signal, i.e., the controlled sound source signal is generated with regard to each frequency.

At step S4, the sound reproducing unit 100 reproduces the optimized sound source signal, i.e., the controlled sound source signal, received from the multi-channel signal generator 230 of the signal analyzing and generating unit 200, through the multi-channel audio amplifier 120 and the speaker 110. Accordingly, at step S5, a pre-determined position where the sound is reproduced is generated within the listening space.

In this exemplary embodiment, the sound reproducing apparatus corresponds to cases in which variables such as a dimension of the listening space, a position where a plurality of speakers 110 is installed within the listening space, a position of a listener, etc. are arbitrarily determined. Thus, in this case, the signal analyzer 220 is included for calculating the transfer function since the transfer function is varied every time when the variables are changed.

Meanwhile, the following three adjustments are possible if a user controls the sound field in the listening space. That is, there are functions of (i) setting the number of acoustic bright points, (ii) controlling the position of each point, and (iii) controlling the intensity of each point. Several setting points are respectively numbered, and the position and intensity of a corresponding number are transmitted to the signal analyzing and generating unit 200. At this time, input solutions of N channels are determined according to the solutions above obtained.

First, if a single acoustic focusing point is used, a listener may feel as if sound is generated at the point where the acoustic focusing point is positioned. If the intensity of the acoustic focusing point is adjusted, a listener recognizes that a sense of distance from listening sound is changed. For example, if the intensity of the acoustic focusing point is decreased, a listener recognizes as if the sound is heard from a longer distance without change in a direction of sound. If the position of the acoustic focusing point becomes closer to a listener's ear, s/he hears the sound focused on her/him and feels a sense of realism.

Second, if a plurality of acoustic focusing points are used, a listener may feel as if sound is generated at not less than two positions since there are not less than two pre-determined positions where the sound is heard as if it is reproduced. Further, there are one case that different sound sources are used in respective acoustic focusing points and the other case that one sound source (i.e., the same sound source) is used in the respective acoustic focusing points.

In the case where the different sound sources are used in the respective acoustic focusing points, it is heard as if different sound is reproduced at not less than two pre-determined positions, and it is thus felt as if sound is generated in different directions where the acoustic focusing points are positioned. For example, if one acoustic focusing point of a violin sound source is used in front of a listener and another acoustic focusing point of a piano sound source is used in back of the listener, the listener may feel a sense of realism as if s/he is placed between a violin player and a piano player. This may be equally applied to a lot of points.

In the case where identical sound sources are used in the respect acoustic focusing points, it may give a different sense of space in accordance with combination of the acoustic focusing points. That is, the positions of the acoustic focusing points are adjusted to increase magnitude difference and phase difference of the sound outputted from the respective speakers. For example, it is heard as if different sound is reproduced at not less than two pre-determined positions, and it is thus possible to make wet sound of which reverberation time is long like an echo in a large concert hall. On the contrary, it is possible to make dry sound of which reverberation time is short. In other words, a listener may feel as if s/he is placed in a different space from an actual place where s/he is actually placed.

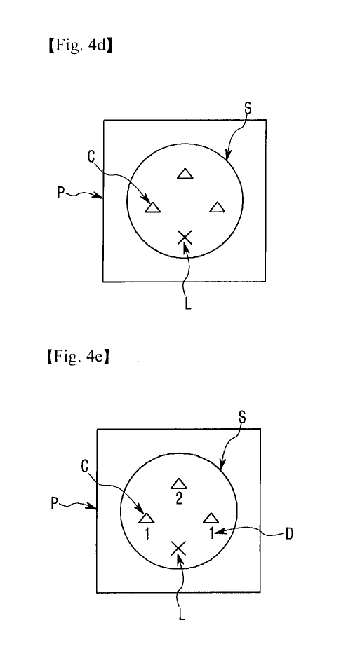

FIGS. 4a to 4e are schematic views showing that a listening space, a listener position and an acoustic focusing point are displayed on a touch panel according to the exemplary embodiments. The input device 310 includes a touch panel P on which a user (i.e., a listener) can draw the listening space S with his/her hands.

As shown in FIG. 4a, a user can draw the listening space S on the touch panel P with his/her finger, a pen or the like. The listening space S is displayed as a space which is closed by a closed curve, different in color from an outer space thereof, on the touch panel P. At this time, the closed curve may be a circle, a triangle, a quadrangle, or etc.

As shown in FIG. 4b, a user may mark his/her Position L within the listening space S. The user's Position L is displayed as ‘X’, but not limited thereto. Alternatively, the user's Position L may be displayed with a dot or the like symbol, or may be displayed in such a manner that the dot flickers.

As shown in FIG. 4c, the position of the acoustic focusing point C is distant from the listener Position L. There may be provided one acoustic focusing point or more than two acoustic focusing points. The position of the acoustic focusing point C is displayed with a triangle, but not limited thereto. Alternatively, the position of the acoustic focusing point C may be displayed with a dot or the like symbol or may be displayed in such a manner that the dot flickers. At this time, the position of the acoustic focusing point C may be different in the size or color of the dot from the listener Position L. Here, three acoustic focusing points c are displayed. The number of acoustic focusing points c to be generated within the actual listening space S is determined in accordance with how many acoustic focusing points c are marked by a user. Such a displayed the acoustic focusing point C causes the acoustic focusing point C to be generated within the actual listening space, so that a user can listen sound from this the acoustic focusing point C.

As shown in FIG. 4d, a user can move the acoustic focusing point C on an input device and change the position of the acoustic focusing point C. Specifically, if a user wants to change the position of the acoustic focusing point C, s/he may change the position of the acoustic focusing point C by moving (i.e., dragging) it forward, backward, leftward and rightward with the input device 310, and then listen sound from the acoustic focusing point C changed in the position.

As shown in FIG. 4e, a user may press for a predetermined period of time or touch the acoustic focusing point C displayed on the touch panel of the input device, thereby changing the magnitudes D of the sound reproduced in the corresponding acoustic focusing point C. If a user marks the acoustic focusing point C and the position of the acoustic focusing point C is displayed by marking, the magnitudes of the sound reproduced in the acoustic focusing point C is set into a reference value. For example, this reference value may refer to the magnitudes of a “level 1”. Further, if a user wants to change the magnitudes of the sound at the acoustic focusing point C and thus touches the acoustic focusing point C with his/her finger, the magnitudes increases into levels 2, 3, . . . in accordance with the number of touches. In order to decrease the magnitudes of sound, a user may press the acoustic focusing point C for a predetermined period of time, thereby returning to the reference value. For example, if the acoustic focusing point C is successively touched twice within a predetermined period of time, the magnitudes of the sound may be decreased one by one. Any of such concrete methods may be employed. What is important is that a user can give a command to increase or decrease the magnitudes of the sound by touching the acoustic focusing point.

Regarding display of the magnitudes of the sound, the levels 1, 2 and 3 may be respectively displayed as 1, 2 and 3, weak, middle and strong, or etc., but not limited thereto. The display type of the magnitudes can be changed variously.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A sound reproducing apparatus comprising:
a control device configured to receive first and second sound source signals, controls magnitudes and phases of the received first and second sound source signals to be heard as if sound is reproduced at a pre-determined position within a listening space, and to output first and second controlled sound source signals;
a first speaker configured to receive the first controlled sound source signal and to reproduce sound;
a second speaker configured to receive the second controlled sound source signal and to reproduce sound; and
an input device with which a user can draw the listening space and mark the pre-determined position and the user's position in the drawn listening space,
wherein the pre-determined position is distant from the user,
wherein the input device is made of a touch panel and the user can draw the listening space with his/her finger or a pen and mark the pre-determined position and the user's position through the touch panel, and
wherein the control device controls the magnitudes and phases of the first and second sound source signals to be heard as if sound is reproduced at an actual pre-determined position within the listening space corresponding to the pre-determined position marked on the input device, and outputs the first and second controlled sound source signals.

2. A sound reproducing apparatus comprising:
a control device configured to receive first and second sound source signals, to control magnitudes and phases of the received first and second sound source signals so that a sound pressure level in a pre-determined position within a listening space is higher than sound pressure levels in positions except the pre-determined position, and to output first and second controlled sound source signals;
a first speaker configured to receive the first controlled sound source signal and to reproduce sound;
a second speaker configured to receive the second controlled sound source signal and to reproduce sound; and
an input device with which a user can draw the listening space and mark the pre-determined position and the user's position in the drawn listening space,
wherein the pre-determined position is distant from the user,
wherein the input device is made of a touch panel and the user can draw the listening space with his/her finger or a pen and mark the pre-determined position and the user's position through the touch panel, and
wherein the control device controls the magnitudes and phases of the first and second sound source signals to be heard as if sound is reproduced at an actual pre-determined position within the listening space corresponding to the pre-determined position marked on the input device, and outputs the first and second controlled sound source signals.

3. A sound reproducing apparatus comprising:
a control device configured to receive first and second sound source signals, to control magnitudes and phases of the received first and second sound source signals to maximize a ratio of the acoustic potential energy density at a pre-determined position within a listening space to a sum of energy of the first sound source signal and the energy of the second sound source signals, and to output first and second controlled sound source signals;
a first speaker configured to receive the first controlled sound source signal and to reproduce sound;
a second speaker configured to receive the second controlled sound source signal and to reproduce sound; and
an input device with which a user can draw the listening space and mark the pre-determined position and the user's position in the drawn listening space,
wherein the pre-determined position is distant from the user,
wherein the input device is made of a touch panel and the user can draw the listening space with his/her finger or a pen and mark the pre-determined position and the user's position through the touch panel, and
wherein the control device controls the magnitudes and phases of the first and second sound source signals to be heard as if sound is reproduced at an actual pre-determined position within the listening space corresponding to the pre-determined position marked on the input device, and outputs the first and second controlled sound source signals.

4. The sound reproducing apparatus according to any one of claims 1 to 3, wherein
the user can mark one or not less than two pre-determined positions on the touch panel of the input device, and
the control device controls the magnitudes and phases of the first and second sound source signals to be heard as if sound is reproduced at an actual pre-determined position within the listening space corresponding to the one or not less than two pre-determined positions marked on the touch panel of the input device, and outputs the first and second controlled sound source signals.

5. The sound reproducing apparatus according to any one of claims 1 to 3, wherein
the user can move the marked pre-determined position on the touch panel of the input device, and
the control device controls the magnitudes and phases of the first and second sound source signals to be heard as if sound is reproduced at an actual pre-determined position within the listening space corresponding to the pre-determined position moved on the touch panel of the input device, and outputs the first and second controlled sound source signals.

6. The sound reproducing apparatus according to any one of claims 1 to 3, wherein
the input device displays magnitudes of sound reproduced at the pre-determined position,
the user can change the magnitudes of the sound by touching the pre-determined position displayed on the touch panel of the input device, and
the control device controls the magnitudes and phases of the first and second sound source signals to be heard as if sound is reproduced with the changed magnitudes at an actual pre-determined position within the listening space corresponding to the pre-determined position marked on the touch panel of the input device, and outputs the first and second control sound source signals.
